(19) United States
(12) Patent Application Publication
(10) Pub. No.: US 2025/0073586 A1
(43) Pub. Date: Mar. 6, 2025

(54) Control Method and Apparatus for Virtual Object, Device, Medium, and Program Product

(71) Applicant: Tencent Technology (Shenzhen) Company Limited, Shenzhen (CN)

(72) Inventor: Jiakun Shao, Shenzhen (CN)

(21) Appl. No.: 18/950,824

(22) Filed: Nov. 18, 2024

Related U.S. Application Data
(63) Continuation of application No. PCT/CN2023/124729, filed on Oct. 16, 2023.

(30) Foreign Application Priority Data
Nov. 23, 2022 (CN) 202211471379.5

(51) Int. Cl. A63F 13/537; A63F 13/60; A63F 13/837

(52) U.S. Cl. CPC A63F 13/537; A63F 13/60; A63F 13/837

(57) ABSTRACT

Control techniques for human-computer interaction are described herein. The technique includes: displaying a master virtual character and a first slave virtual object located in a virtual scene, the master virtual character and the first slave virtual object having a master-slave relationship; displaying a picture of the first slave virtual object entering an unhealthy state in response to an attribute value of the first slave virtual object being less than a first threshold; and displaying a picture of the first slave virtual object transitioning from the unhealthy state to a healthy state in response to an interaction operation of the master virtual character on a target virtual character. The method provides a new manner for restoring a slave virtual object, which can quickly restore the slave virtual object to a healthy state, thereby reducing the game duration and alleviating the processing pressure on the server.

### RELATED APPLICATION

This application is a continuation application of PCT Application PCT/CN2023/124729, filed Oct. 16, 2023, which claims priority to Chinese Patent Application No. 202211471379.5, filed on Nov. 23, 2022, each entitled “CONTROL METHOD AND APPARATUS FOR VIRTUAL OBJECT, DEVICE, MEDIUM, AND PROGRAM PRODUCT”, and each of which is incorporated herein by reference in its entirety.

### FIELD

Aspects described herein relate to the field of human-computer interaction, and in particular, to a control method and apparatus for a virtual object, a device, a medium, and a program product.

### BACKGROUND

A battle game is a game in which a plurality of user accounts compete in the same scene. For example, a battle game may be a multiplayer online shooting game.

In the related art, a master virtual character may use a skill to summon a pet in a virtual environment. The pet may be: a virtual object, a virtual character, a virtual animal, a puppet, a ghost, a monster, or the like. The master virtual character may control the pet to move, attack an opponent virtual character, or perform a skill. After being seriously injured, the pet in a dying state requires the master virtual character to squat around the pet to rescue it before the pet can be revived.

However, in the foregoing related art, it takes some time for the master virtual character to rescue the pet. The master virtual character can move only after the pet recovers. The entire rescue process makes a single battle last longer, resulting in excessive processing pressure on the server.

### SUMMARY

Aspects described herein provide a control method and apparatus for a virtual object, a device, a medium, and a program product. The technical solutions include the following:

According to an aspect described herein, a control method for a virtual object is provided. The method is performed by a terminal device and includes:
displaying a master virtual character and a first slave virtual object located in a virtual scene, the master virtual character and the first slave virtual object having a master-slave relationship;
displaying a picture of the first slave virtual object entering an unhealthy state in response to an attribute value of the first slave virtual object being less than a first threshold; and
displaying a picture of the first slave virtual object transitioning from the unhealthy state to a healthy state in response to an interaction operation of the master virtual character on a target virtual character, the target virtual character being a virtual character redeemed or defeated by the master virtual character.

According to another aspect described herein, a control apparatus for a virtual object is provided. The apparatus includes:
a display module, configured to display a master virtual character and a first slave virtual object located in a virtual scene, the master virtual character and the first slave virtual object having a master-slave relationship; and
a human-computer interaction module, configured to display a picture of the first slave virtual object entering an unhealthy state in response to an attribute value of the first slave virtual object being less than a first threshold,
the human-computer interaction module being configured to display a picture of the first slave virtual object transitioning from the unhealthy state to a healthy state in response to an interaction operation of the master virtual character on a target virtual character, the target virtual character being a virtual character redeemed or defeated by the master virtual character.

According to another aspect described herein, a terminal device is provided. The terminal device includes: a processor and a memory, the memory having a computer program stored therein, and the computer program being loaded and executed by the processor to implement the control method for a virtual object according to the foregoing aspect.

According to another aspect described herein, a computer-readable storage medium is provided, the computer-readable storage medium having a computer program stored therein, and the computer program being loaded and executed by a processor to implement the control method for a virtual object according to the foregoing aspect.

According to another aspect described herein, a computer program product is provided, the computer program product including a computer program, the computer program being stored in a computer-readable storage medium; and the computer program being read and executed by a processor of a terminal device from the computer-readable storage medium, causing the terminal device to perform the control method for a virtual object according to the foregoing aspect.

The technical solutions provided in this application include at least the following beneficial effects:
a master virtual character and a first slave virtual object located in a virtual scene are displayed; a picture of the first slave virtual object entering an unhealthy state is displayed in response to an attribute value of the first slave virtual object being less than a first threshold; and a picture of the first slave virtual object transitioning from the unhealthy state to healthy state is displayed in response to an interaction operation of the master virtual character on a target virtual character, the target virtual character being a virtual character redeemed or defeated by the master virtual character. This application provides a new manner for restoring a state of a slave virtual object, which can quickly restore the slave virtual object to a healthy state, thereby reducing the game duration and alleviating the processing pressure on the server.

### BRIEF DESCRIPTION OF THE DRAWINGS

FIG. 1 is a schematic diagram of a control method for a virtual object according to an illustrative aspect described herein.

FIG. 2A is a schematic diagram of an application mode of a control method for a virtual object in a virtual scene according to an aspect described herein.

FIG. 2B is a schematic diagram of an application mode of a control method for a virtual object in a virtual scene according to an aspect described herein.

FIG. 3 is a structural block diagram of a computer system according to an illustrative aspect described herein.

FIG. 4 is a flowchart of a control method for a virtual object according to an illustrative aspect described herein.

FIG. 5 is a flowchart of a control method for a virtual object according to an illustrative aspect described herein.

FIG. 6 is a schematic diagram of a control method for a virtual object according to an illustrative aspect described herein.

FIG. 7 is a schematic diagram of a virtual object inheriting a skill of a target virtual character according to an illustrative aspect described herein.

FIG. 8 is a schematic diagram of a virtual object inheriting a skill of a target virtual character according to an illustrative aspect described herein.

FIG. 9 is a schematic diagram of a virtual object inheriting a skill of a target virtual character according to an illustrative aspect described herein.

FIG. 10 is a schematic diagram of switching a virtual object according to an illustrative aspect described herein.

FIG. 11 is a flowchart of a control method for a virtual object according to an illustrative aspect described herein.

FIG. 12 is a block diagram of a control apparatus for a virtual object according to an illustrative aspect described herein.

FIG. 13 is a schematic diagram of an apparatus structure of a computer device according to an illustrative aspect described herein.

### DETAILED DESCRIPTION

To make objectives, technical solutions, and advantages of this application clearer, implementations are further described below in detail with reference to the accompanying drawings.

First, nouns and terms involved in the aspects described herein are briefly introduced.

Virtual environment: It is a virtual environment displayed (or provided) when an application runs on a terminal device. The virtual environment may be a simulated world of a real world, or may be a semi-simulated semi-fictional three-dimensional world, or may be an entirely fictional three-dimensional world. The virtual environment may be any one of a two-dimensional virtual environment, a 2.5-dimensional virtual environment, and a three-dimensional virtual environment. In some aspects, the virtual environment is further configured for a virtual environment battle between at least two virtual characters, and there are virtual resources available to at least two virtual characters in the virtual environment. In some aspects, the virtual environment includes a lower left corner region and an upper right corner region that are symmetrical. Virtual characters on two opposing camps each occupy one region.

Virtual character: It is a movable object in a virtual environment. The movable object may be at least one of a virtual character, a virtual animal, or an animated character. In some aspects, when the virtual environment is a three-dimensional virtual environment, virtual characters may be three-dimensional models. Each virtual character has a shape and a volume in the three-dimensional virtual environment, and occupies some space in the three-dimensional virtual environment. In some aspects, the virtual character is a three-dimensional character constructed based on a three-dimensional human skeleton technology. The virtual character wears different skins to implement different appearances. In some implementations, the virtual character may be alternatively implemented by using a 2.5-dimensional model or a two-dimensional model. This is not limited in the aspects described herein.

Multiplayer online battle arena: It is an arena in which different virtual teams on at least two opposing camps occupy respective map regions in a virtual environment, and compete against each other using a specific victory condition as a goal. The victory condition includes, but is not limited to at least one of occupying a fort or destroying a fort of the opposing camp, killing virtual characters in the opposing camp, ensuring own survival in a specified scene and time, seizing a specific resource, or outscoring the opponent within a specified time. The battle arena may take place in rounds. The same map or different maps may be used in different rounds of the battle arena. Each virtual team includes one or more virtual characters, for example, one virtual character, two virtual characters, three virtual characters, or five virtual characters.

In response to: It is used for representing a condition or status on which one or more operations to be performed depend. When the condition or status is met, the one or more operations may be performed immediately or after a set delay. Unless explicitly stated, there is no limitation on the order in which the plurality of operations are performed.

Aspects described herein provide technical solutions of a control method for a virtual object. The method may be performed by a computer device, and the computer device includes a terminal device or a server. For example, a client of the following application supporting a virtual scene is run on the terminal device, and the server provides a backend service for the client of the application. In the aspects described herein, all display-related operations may be performed by the terminal device or the client running on the terminal device, while display-unrelated operations may be performed by the terminal device or the client running on the terminal device, or by the server. This is not limited in this application.

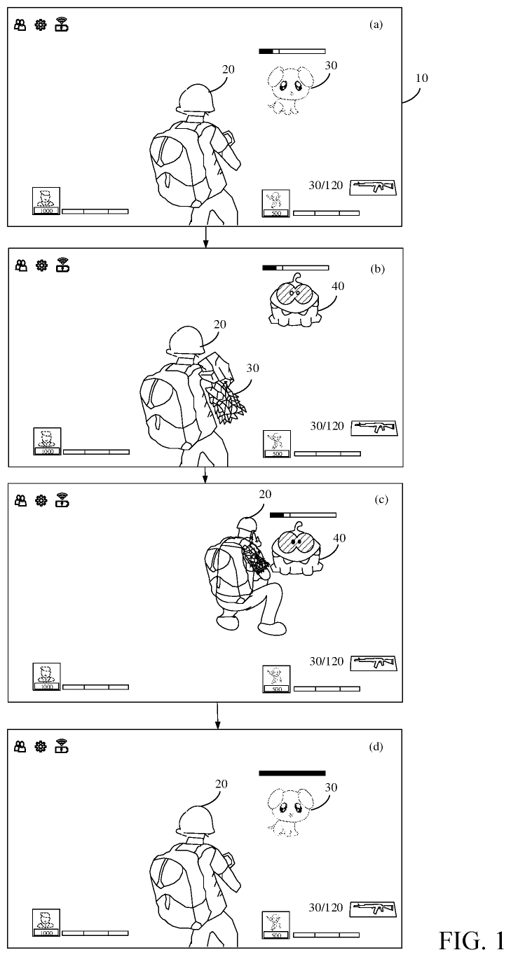

As shown in (a) of FIG. 1, a virtual environment picture 10 is displayed on a user interface. The virtual environment picture 10 includes a master virtual character 20 and a first slave virtual object 30 of the master virtual character 20. In response to the first slave virtual object 30 receiving an attack operation, in a case that an attribute value of the first slave virtual object 30 is less than a first threshold, the computer device displays a picture of the first slave virtual object 30 entering an unhealthy state.

The master virtual character 20 and the first slave virtual object 30 have a master-slave relationship.

The unhealthy state may be a health value of the first slave virtual object 30 being less than the first threshold.

The healthy state may be the health value of the first slave virtual object 30 being at a peak, or the healthy state may be the health value of the first slave virtual object 30 being greater than a second threshold.

As shown in (b) of FIG. 1, after the first slave virtual object 30 enters an unhealthy state, the first slave virtual object 30 is automatically attached to a body part of the master virtual character 20 for automatic recovery. A target virtual character 40 is displayed in the figure.

The target virtual character 40 is a virtual character tamed or defeated or purchased or redeemed by the master virtual character 20, but is not limited thereto. This is not specifically limited in the aspects described herein.

In some aspects, the target virtual character 40 is in a corpse state after being defeated by the master virtual character 20, or the target virtual character 40 is in the unhealthy state after being defeated by the master virtual character 20.

In some aspects, the target virtual character 40 in the unhealthy state is kneeling, lying face down, or lying face up on the ground, but is not limited thereto. This is not specifically limited in the aspects described herein.

As shown in (c) of FIG. 1, the master virtual character 20 moves to a vicinity of the target virtual character 40 in the virtual scene. As shown in (d) of FIG. 1, the computer device regenerates the first slave virtual object 30 from the unhealthy state to the healthy state by using the target virtual character 40 in response to an interaction operation of the master virtual character 20 on the target virtual character 40, and displays a picture of the first slave virtual object 30 transitioning from the unhealthy state to the healthy state.

For example, the master virtual character 20 owns a virtual summon chip for summoning the first slave virtual object 30. The computer device regenerates the first slave virtual object 30 from the unhealthy state to the healthy state by using the target virtual character 40 in response to the master virtual character 20 transforming attribute information with the target virtual character 40 by using the virtual summon chip.

The virtual summon chip is configured for summoning a slave virtual object in the healthy state to enter an independent form or an attached form.

In some aspects, the form of the slave virtual object includes: at least one of a backpack form, an attached form, or an independent form, but is not limited thereto. This is not specifically limited in the aspects described herein.

The backpack form is a state in which the slave virtual object is in an inactive state and is placed in a backpack in a form of a chip.

The attached form (also referred to as a second form) is a state in which the slave virtual object is in an inactive state, and the slave virtual object is attached to a body part of the master virtual character 20 to become a part of the master virtual character 20.

The independent form (also referred to as a first form) is a state in which the slave virtual object is in an inactive state and the slave virtual object acts independently of the master virtual character 20.

In some aspects, the attribute information includes health value information and skill information.

For example, the computer device regenerates the health value of the first slave virtual object 30 from a state less than the first threshold to a peak state based on the target virtual character 40 in response to the master virtual character 20 transforming the health value information with the target virtual character 40 by using the virtual summon chip.

For example, in a case that the first slave virtual object 30 is in the healthy state, the virtual summon chip may be configured for summoning the slave virtual object in the healthy state to enter the independent form or the attached form. In a case that the first slave virtual object 30 is in the unhealthy state, for example, the health value of the first slave virtual object 30 is less than 20%, the computer device regenerates the health value of the first slave virtual object 30 from 20% to 100% based on the target virtual character 40 in response to the master virtual character 20 transforming the health value information with the target virtual character 40 by using the virtual summon chip.

For example, the computer device regenerates the first slave virtual object 30 from the unhealthy state to the healthy state based on the target virtual character 40 in response to the master virtual character 20 transforming the skill information with the target virtual character 40 by using the virtual summon chip, and the first slave virtual object 30 inherits a skill of the target virtual character 40.

In some aspects, the computer device regenerates the first slave virtual object 30 from the unhealthy state to the healthy state based on the target virtual character 40 in response to the master virtual character 20 transforming the skill information with the target virtual character 40 by using the virtual summon chip, and the first slave virtual object 30 carries both a first skill and a second skill.

The first skill is a skill unique to the first slave virtual object 30, and the second skill is a skill unique to the target virtual character 40.

For example, if the target virtual character 40 has an exploration skill, and the first slave virtual object 30 in the unhealthy state has a shield skill. The computer device regenerates the first slave virtual object 30 from the unhealthy state to the healthy state based on the target virtual character 40 in response to the master virtual character 20 transforming the skill information with the target virtual character 40 by using the virtual summon chip, and the first slave virtual object 30 has both the exploration skill and the shield skill.

In some aspects, the computer device regenerates the first slave virtual object 30 from the unhealthy state to the healthy state by using the target virtual character 40 in response to the master virtual character 20 transforming the skill information with the target virtual character 40 by using the virtual summon chip, and the first slave virtual object 30 obtains a third skill.

The third skill is regenerated by fusing a first skill and a second skill; and The first skill is a skill unique to the first slave virtual object 30, and the second skill is a skill unique to the target virtual character 40.

For example, attribute information of the first skill and attribute information of the second skill are obtained; and skill fusion is performed on the first skill and the second skill based on an attribute association relationship between the first skill and the second skill, to obtain the third skill.

For example, if the first skill is a skill with a “wood” attribute, and the second skill is a skill with a “fire” attribute, the computer device performs skill fusion on the first skill and the second skill based on an attribute association relationship between the first skill and the second skill, to obtain the third skill, where the third skill is a skill with a “gold” attribute. For example, when the master virtual character casts the first skill, a wooden prisoner cage appears, and may be configured for trapping the target virtual character or the opponent virtual character in the wooden prisoner cage. When the master virtual character casts the second skill, the master virtual character ejects a fireball. In a case that the master virtual character owns and uses the third skill, a metal prisoner cage burning in flames appears.

For example, if the target virtual character 40 has an exploration skill, and the first slave virtual object 30 in the unhealthy state has a shield skill, the computer device regenerates the first slave virtual object 30 from the unhealthy state to the healthy state based on the target virtual character 40 in response to the master virtual character 20 transforming the skill information with the target virtual character 40 by using the virtual summon chip, and the first slave virtual object 30 has a skill regenerated by fusing the exploration skill and the shield skill: a clone skill.

In some aspects, the computer device displays a picture of the first slave virtual object 30 entering the unhealthy state, and the first slave virtual object 30 switching from a first form to a second form in response to the attribute value of the first slave virtual object 30 being less than the first threshold.

The first form (also referred to as an independent form) is a form in which the first slave virtual object 30 acts independently of the master virtual character 20.

The second form (also referred to as an attached form) is a form in which the first slave virtual object 30 is attached to a body part of the master virtual character 20 to become a part of the master virtual character 20.

In some aspects, the computer device displays a recovery progress bar in response to the first slave virtual object 30 in the unhealthy state switching from the first form to the second form.

The recovery progress bar is configured for representing a recovery progress of the first slave virtual object 30 in the unhealthy state, and when the recovery progress bar is full, the first slave virtual object 30 transitions from the unhealthy state to the healthy state.

In some aspects, the computer device automatically switches the first slave virtual object 30 from the second form to the first form after the first slave virtual object 30 transitions from the unhealthy state to the healthy state.

In some aspects, the computer device freely switches the first slave virtual object 30 between the first form and the second form in response to a form switching operation on the first slave virtual object 30 in the healthy state.

The first slave virtual object 30 in the first form can lock and/or attack the target virtual character 40; and the first slave virtual object 30 in the second form can increase an attribute value of the master virtual character 20. For example, a defense value is increased.

In some aspects, the master virtual character 20 further owns a second slave virtual object, and the computer device switches the first slave virtual object in the second form to the second slave virtual object in response to a switching operation on a slave virtual object.

For example, the computer device switches the first slave virtual object 30 attached to the body part of the master virtual character 20 to the second slave virtual object in response to the switching operation on the slave virtual object, and the second slave virtual object inherits a health value of the first slave virtual object 30 based on a health value percentage.

The health value percentage is a ratio of a current health value of the first slave virtual object 30 to a total health value of the first slave virtual object 30.

For example, in a case that the first slave virtual object 30 in the attached form is in the unhealthy state, the computer device switches the first slave virtual object 30 attached to the body part of the master virtual character 20 to the second slave virtual object in response to the switching operation on the slave virtual object, and the second slave virtual object is in the unhealthy state.

For example, the health value of the first slave virtual object 30 is 50%, and the health value of the second slave virtual object is 100%. The computer device switches the first slave virtual object 30 to the second slave virtual object in response to the switching operation on the slave virtual object, and the second slave virtual object inherits the health value of the first slave virtual object 30 based on the health value percentage. In other words, the health value of the second slave virtual object changes to 50%, and the health value of the first slave virtual object 30 changes to 100%.

For example, if the total health value of the first slave virtual object 30 is 1000, the health value of the first slave virtual object 30 in the unhealthy state is 200, and the total health value of the second slave virtual object is 2000, the computer device responds to the switching operation on the slave virtual object, the second slave virtual object inherits the health value of the first slave virtual object 30 based on the health value percentage, and the health value of the second slave virtual object after switching is 400.

In conclusion, according to the method provided in this aspect, a master virtual character and a first slave virtual object located in a virtual scene are displayed; the first slave virtual object enters an unhealthy state in response to an attribute value of the first slave virtual object being less than a first threshold; the master virtual character moves to a vicinity of a target virtual character in the virtual scene; and the first slave virtual object is regenerated from the unhealthy state to a healthy state by using the target virtual character in response to an interaction operation of the master virtual character on the target virtual character. This application provides a new manner for restoring a state of a slave virtual object, which can quickly restore the slave virtual object to a healthy state, thereby reducing the game duration and alleviating the processing pressure on the server, further improving the efficiency of human-computer interaction and improving the user experience.

The aspects described herein provide a control method and apparatus for a virtual object, a device, a medium, and a program product, which can control a virtual object in a virtual scene in a flexible and concise manner, thereby improving the efficiency of human-computer interaction and the user experience. To facilitate easier understanding of the control method for a virtual object in a virtual scene provided in the aspects described herein, an illustrative implementation scenario of the control method for a virtual object in a virtual scene provided in the aspects described herein is first described. A virtual scene in the control method for a virtual object in a virtual scene provided in the aspects described herein may be outputted entirely based on a terminal device, or outputted collaboratively based on a terminal device and a server.

In some aspects, the virtual scene may be an environment for virtual objects (for example, target virtual characters) to interact. For example, the virtual scene may be for game characters to battle in the virtual scene. Two parties may interact in the virtual scene by controlling actions of the game characters, so that users can relieve life stress during the game.

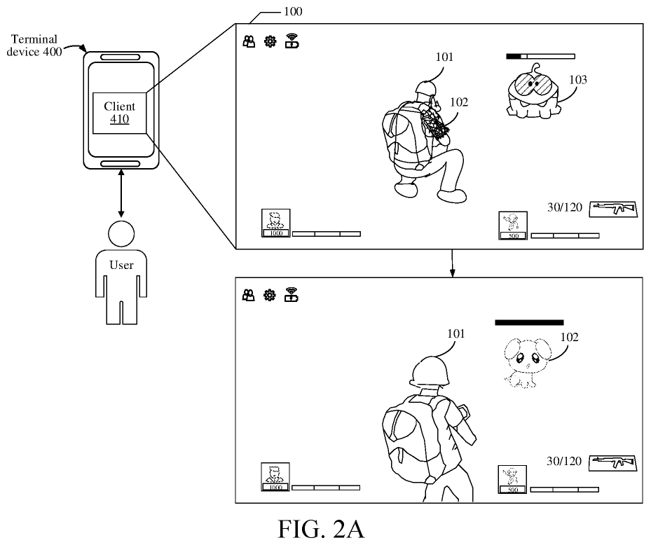

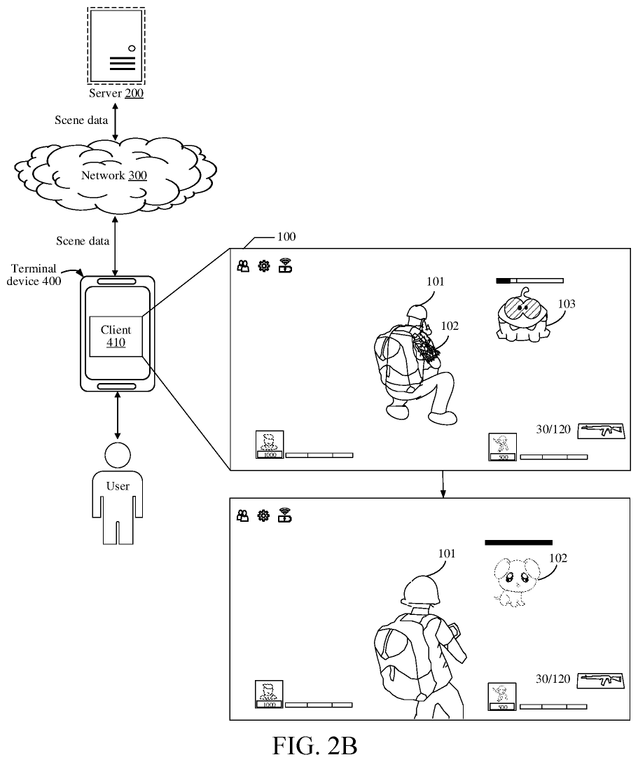

In an implementation scenario, FIG. 2A is a schematic diagram of an application mode of a control method for a virtual object in a virtual scene according to an aspect described herein. The method is applicable to some application modes in which relevant data of a virtual scene 100 can be calculated completely depending on computing power of graphics processing hardware of a terminal device 400, for example, stand-alone/offline mode games. The virtual scene is outputted by various different types of terminal devices 400 such as a smartphone, a tablet computer, and a virtual reality/augmented reality device.

For example, types of the graphics processing hardware include a central processing unit (CPU) and a graphics processing unit (GPU).

When visual perception of the virtual scene 100 is formed, the terminal device 400 calculates, by using graphics computing hardware, data required for display, completes loading, parsing, and rendering of the displayed data, and outputs, by using graphics output hardware, a video frame that can form the visual perception of the virtual scene. For example, a two-dimensional video frame is presented on a display screen of a smartphone, or a video frame that achieves a three-dimensional display effect is projected on lenses of augmented reality/virtual reality glasses. In addition, to enrich a perception effect, the terminal device 400 may further use different hardware to form one or more of auditory perception, tactile perception, motion perception, and taste perception.

For example, if a client 410 (for example, a stand-alone game application) is run on the terminal device 400, a virtual scene including role playing is outputted during running of the client 410. The virtual scene may be an environment for game characters to interact, for example, may be a plain, a street, or a valley for game characters to battle. Using an example in which the virtual scene 100 is displayed from a third-person perspective, a master virtual character 101 is displayed in the virtual scene 100. The master virtual character 101 may be a game character controlled by a user, that is, the master virtual character 101 is controlled by a real user and moves in the virtual scene 100 in response to an operation performed by the real user on a controller (for example, a touchscreen, a voice switch, a keyboard, a mouse, or a joystick). For example, when the real user moves a joystick (including a virtual joystick and a real joystick) to the right, the master virtual character 101 moves to the right in the virtual scene 100. The real user may further control the master virtual character 101 to remain stationary, to jump, and to perform a shooting operation.

For example, the master virtual character 101 and a first slave virtual object 102 in an attached form are displayed in the virtual scene 100. The first slave virtual object 102 is attached to the master virtual character 101 (for example, the first slave virtual object 102 may be attached to an arm of the master virtual character 101 in a shape of an armor, thereby becoming a part of the master virtual character 101). Then, the client 410 displays the first slave virtual object 102 in an unhealthy state in response to the first slave virtual object 102 receiving an attack operation. The client 410 regenerates the first slave virtual object 102 from the unhealthy state to a healthy state by using a target virtual character 103 in response to an interaction operation of the master virtual character 101 on the target virtual character 103. In this way, the first slave virtual object 102 can be quickly revived, and the virtual object in the virtual scene can be controlled, thereby improving the efficiency of human-computer interaction and the user experience.

In another implementation scenario, FIG. 2B is a schematic diagram of an application mode of a control method for a virtual object in a virtual scene according to an aspect described herein. The method is applied to a terminal device 400 and a server 200, and is applicable to an application mode in which a virtual scene is calculated depending on computing power of the server 200 and the virtual scene is outputted at the terminal device 400.

Using the forming of the visual perception of the virtual scene 100 as an example, the server 200 calculates displayed data (for example, scene data) related to the virtual scene and transmits the data to the terminal device 400 via a network 300. The terminal device 400 relies on graphics computing hardware to load, parse, and render the displayed data, and relies on graphics output hardware to output the virtual scene to form the visual perception. For example, a two-dimensional video frame may be presented on a display screen of a smartphone, or a video frame that achieves a three-dimensional display effect may be projected on lenses of augmented reality/virtual reality glasses. For perception of a form of the virtual scene, output may be performed by using corresponding hardware of the terminal device 400, for example, auditory perception may be formed by using a microphone, and tactile perception may be formed by using a vibrator.

For example, the client 410 (for example, a network version of a game application) is run on the terminal device 400, and performs game interaction with another user by connecting to the server 200 (for example, a game server). The terminal device 400 outputs the virtual scene 100 of the client 410. Using an example in which the virtual scene 100 is displayed from a third-person perspective, a master virtual character 101 is displayed in the virtual scene 100. The master virtual character 101 may be a game character controlled by a user, that is, the master virtual character 101 is controlled by a real user and moves in the virtual scene 100 in response to an operation performed by the real user on a controller (for example, a touchscreen, a voice switch, a keyboard, a mouse, or a joystick). For example, when the real user moves a joystick to the right, the master virtual character 101 moves to the right in the virtual scene 100. The real user may further control the master virtual character 101 to remain stationary, to jump, and to perform a shooting operation.

For example, the master virtual character 101 and a first slave virtual object 102 in an attached form are displayed in the virtual scene 100. The first slave virtual object 102 is attached to the master virtual character 101 (for example, the first slave virtual object 102 may be attached to an arm of the master virtual character 101 in a shape of an armor, thereby becoming a part of the master virtual character 101). Then, the client 410 displays the first slave virtual object 102 in an unhealthy state in response to the first slave virtual object 102 receiving an attack operation. The client 410 regenerates the first slave virtual object 102 from the unhealthy state to a healthy state by using a target virtual character 103 in response to an interaction operation of the master virtual character 101 on the target virtual character 103. In this way, the first slave virtual object 102 can be quickly revived, and the virtual object in the virtual scene can be controlled, thereby improving the efficiency of human-computer interaction and the user experience.

In some aspects, the terminal device 400 may implement the control method for a virtual object in a virtual scene provided in the aspects described herein by running a computer program. For example, the computer program may be a native program or a software module in an operating system; or may be a native application, that is, a program that needs to be installed in an operating system to run, for example, a shooting game APP (that is, the client 410); or may be an applet, that is, a program that only needs to be downloaded into a browser environment to run; or may be a game applet that can be embedded in any APP. In conclusion, the computer program may be any form of an application, a module, or a plug-in.

Using an example in which the computer program is an application, in actual implementation, an application supporting a virtual scene is installed and run on the terminal device 400. The application may be any one of a first-person shooting (FPS) game, a third-person shooting game, a virtual reality application, and a three-dimensional map program. The user uses the terminal device 400 to operate the virtual object located in the virtual scene to perform activities. The activities include, but are not limited to: at least one of adjusting body posture, crawling, walking, running, riding, jumping, driving, picking, shooting, attacking, throwing, or constructing a virtual building. For example, the virtual object may be a virtual character, for example, a simulated character or an animated character.

In some other aspects, the aspects described herein may further be implemented by means of cloud technology, and the cloud technology is a hosting technology that unifies a series of resources such as hardware, software, and networks in a wide area network or a local area network to implement computing, storage, processing, and sharing of data.

The cloud technology is a collective name of a network technology, an information technology, an integration technology, a management platform technology, an application technology, and the like based on an application of a cloud computing business mode, and may form a resource pool, which is used as required, and is flexible and convenient. The cloud computing technology becomes an important support. A backend service of a technical network system requires a large amount of computing and storage resources.

For example, the server 200 in FIG. 2B may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, big data, and an artificial intelligence platform. The terminal device 400 may be a smartphone, a tablet computer, a notebook computer, a desktop computer, a smart speaker, a smartwatch, or the like, but is not limited thereto. The terminal device 400 and the server 200 may be directly or indirectly connected in a wired or wireless communication manner. This is not limited in the aspects described herein.

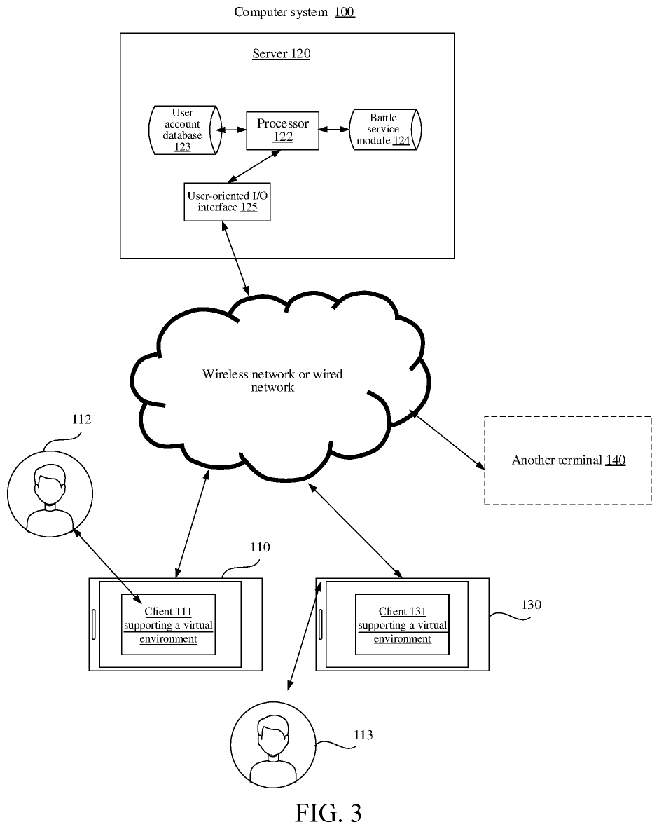

FIG. 3 is a structural block diagram of a computer system according to an illustrative aspect described herein. The computer system 100 includes: a first terminal device 110, a server 120, and a second terminal device 130.

A client 111 supporting a virtual environment is installed and run on the first terminal device 110, and the client 111 may be a multiplayer online battle program. When the first terminal device runs the client 111, a user interface of the client 111 is displayed on a screen of the first terminal device 110. The client 111 may be any one of a battle royale shooting game, a virtual reality (VR) application, an augmented reality (AR) program, a three-dimensional map program, a VR game, an AR game, a first-person shooting (FPS) game, a third-person shooting (TPS) game, a multiplayer online battle arena (MOBA) game, and a simulation game (SLG). In this aspect, an example in which the client 111 is a MOBA game is used for description. The first terminal device 110 is a terminal device used by a first user 112. The first user 112 uses the first terminal device 110 to control a first virtual character located in the virtual environment to perform activities or operate a virtual item owned by the first virtual character, and the first virtual character may be referred to as a virtual character of the first user 112. The first user 112 may perform operations such as assembling, disassembling, and unloading on a virtual item owned by the first virtual character. This is not limited in this application. For example, the first virtual character is a first virtual role, for example, a simulated character or an animated character.

A client 131 supporting a virtual environment is installed and run on the second terminal device 130, and the client 131 may be a multiplayer online battle program. When the second terminal device 130 runs the client 131, a user interface of the client 131 is displayed on a screen of the second terminal device 130. The client may be any one of an escape shooting game, a VR application, an AR program, a three-dimensional map program, a VR game, an AR game, an FPS game, a TPS game, a MOBA game, and an SLG. In this aspect, an example in which the client is a MOBA game is used for description. The second terminal device 130 is a terminal device used by a second user 113. The second user 113 uses the second terminal device 130 to control a second virtual character located in the virtual environment to perform activities and operate a virtual item owned by the second virtual character, and the second virtual character may be referred to as a virtual character of the second user 113. For example, the second virtual character is a second virtual role, for example, a simulated character or an animated character.

In some aspects, the first virtual character and the second virtual character are located in the same virtual environment. In some aspects, the first virtual character and the second virtual character may belong to the same camp, the same team, or the same organization, have a friend relationship with each other, or have a temporary communication permission. In some aspects, the first virtual character and the second virtual character may belong to different camps, different teams, or different organizations, or have a hostile relationship with each other.

In some aspects, the client installed on the first terminal device 110 is the same as the client installed on the second terminal device 130, or the clients installed on the two terminal devices are the same type of clients of different operating system platforms (Android system or iOS system). The first terminal device 110 may generally refer to one of a plurality of terminal devices, and the second terminal device 130 may generally refer to another one of the plurality of terminal devices. In this aspect, the first terminal device 110 and the second terminal device 130 are merely used as an example for description. The device types of the first terminal device 110 and the second terminal device 130 are the same or different. The device types include: at least one of a smartphone, a tablet computer, an e-book reader, an MP3 player, an MP4 player, a laptop portable computer, or a desktop computer.

FIG. 3 shows only two terminal devices. However, a plurality of other terminal devices 140 may access the server 120 in different aspects. In some aspects, one or more terminal devices 140 are terminal devices corresponding to a developer. A developing and editing platform for a client supporting a virtual environment is installed on the terminal device 140. The developer may edit and update the client on the terminal device 140 and transmit an updated client installation package to the server 120 through a wired or wireless network. The first terminal device 110 and the second terminal device 130 may download the client installation package from the server 120 to update the client.

The first terminal device 110, the second terminal device 130, and the other terminal devices 140 are connected to the server 120 through a wireless network or a wired network.

The server 120 includes at least one of a server, a plurality of servers, a cloud computing platform, or a virtualization center. The server 120 is configured to provide a backend service for a client supporting a three-dimensional virtual environment. In some aspects, the server 120 is responsible for primary computing work, and the terminal device is responsible for secondary computing work; or the server 120 is responsible for secondary computing work, and the terminal device is responsible for primary computing work; or a distributed computing architecture is adopted between the server 120 and the terminal device to perform collaborative computing.

In an illustrative example, the server 120 includes a processor 122, a user account database 123, a battling service module 124, and a user-oriented input/output (I/O) interface 125. The processor 122 is configured to load instructions stored in the server 120, and process data in the user account database 123 and the battle service module 124. The user account database 123 is configured to store data of user accounts used by the first terminal device 110, the second terminal device 130, and the other terminal devices 140, for example, profile pictures of the user accounts, nicknames of the user accounts, battle effectiveness indexes of the user accounts, and service zones of the user accounts. The battle service module 124 is configured to provide a plurality of battle rooms for the users for a battle, for example, a 1V1 battle, a 3V3 battle, or a 5V5 battle. The user-oriented I/O interface 125 is configured to establish communication with the first terminal device 110 and/or the second terminal device 130 through a wireless network or a wired network for data exchange.

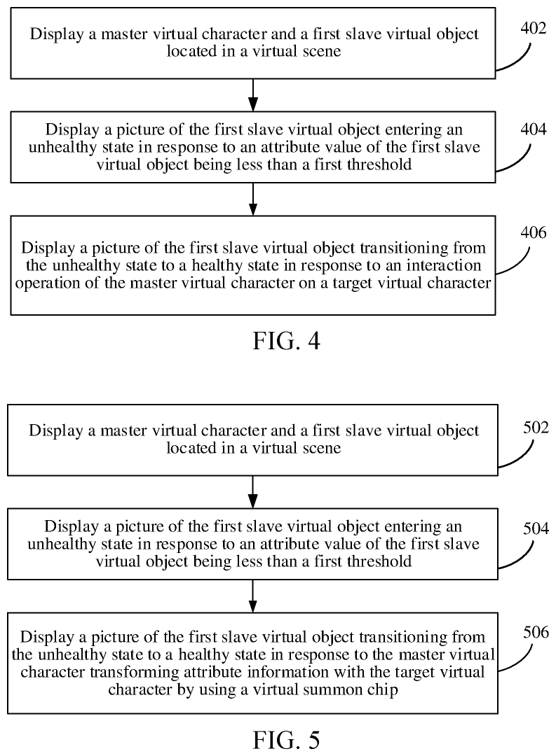

FIG. 4 is a flowchart of a control method for a virtual object according to an illustrative aspect described herein. This method may be performed by a terminal device in the system shown in FIG. 3 or a client on the terminal device. The method includes:
Operation 402: Display a master virtual character and a first slave virtual object located in a virtual scene.

The virtual scene is a virtual activity space provided by an application in the terminal device during running, for the master virtual character to perform various activities in the virtual activity space.

For example, the virtual scene is a two-dimensional picture that is obtained by performing picture capture on a three-dimensional virtual environment and that is displayed on the client. For example, a shape of the virtual scene is determined according to a shape of a display screen of the terminal device, or according to a shape of a user interface of the client. Using an example in which the display screen of the terminal device is rectangular, a virtual environment picture is also displayed as a rectangular picture.

The master virtual character is a virtual character controlled by the client. The client controls activities of the master virtual character in the virtual environment according to received user operations.

For example, the activities of the master virtual character in the virtual scene include: walking, running, jumping, climbing, lying down, attacking, skill casting, prop picking, and message sending, but are not limited to this. This is not limited in the aspects described herein.

The first slave virtual object is a movable object with different functions owned by the master virtual character in the virtual scene. The master virtual character and the first slave virtual object have a master-slave relationship. In some aspects, the first slave virtual object is a virtual character controlled by a server, or the first slave virtual object is controlled by a target algorithm in the application running in the terminal device, that is, the first slave virtual object is an artificial intelligence virtual character. Certainly, in the aspects described herein, a character type of the first slave virtual object is not limited to the artificial intelligence virtual character. The first slave virtual object may alternatively be a virtual character controlled by the user. In some other aspects, the master-slave relationship may be understood as that the master virtual character can control an action of the first slave virtual object, control the first slave virtual object to cast a skill, or control a character state of the first slave virtual object.

The first slave virtual object may be obtained through at least one of picking up, robbing, and purchasing. This is not limited in this application.

In some aspects, the functions of the first slave virtual object include at least one of enhancing a strength of the master virtual character, enhancing a speed of the master virtual character, providing a defense capability, providing an exploration capability, or providing an attack capability, but are not limited to this. This is not limited in this application.

For example, the client controls the first slave virtual object to be attached to a body part of the master virtual character in response to a first instruction on the first slave virtual object. For example, the first slave virtual object is attached to an arm of the master virtual character, the first slave virtual object is attached to a leg of the master virtual character, or the first slave virtual object is attached to the back of the master virtual character, but is not limited to this. This is not limited in the aspects described herein. Certainly, the client may alternatively control the first slave virtual object to be attached around the master virtual character in response to the first instruction on the first slave virtual object. For example, if the first slave virtual object is controlled to be attached to a bracelet or a wand of the master virtual character, or the first slave virtual object is controlled to be within a threshold range near the master virtual character, the first slave virtual object is considered to be attached to the master virtual character.
Operation 404: Display a picture of the first slave virtual object entering an unhealthy state in response to an attribute value of the first slave virtual object being less than a first threshold.

The attribute value in the aspects described herein is a value describing an attribute of the first slave virtual object. The attribute may be at least one of life, skill, defense, or attack, but is not limited thereto. This is not specifically limited in the aspects described herein.

The unhealthy state is the attribute value of the first slave virtual object being less than or equal to the first threshold. The attribute value includes, but is not limited to, a health value, a skill value, a defense value, and an attack value. In the aspects described herein, the first threshold may be a fixed value preset by a developer, or may be set by the user controlling the master virtual character. For example, during the battle, the user can flexibly set the value of the first threshold based on a real-time battle status. In still some other aspects, the computer device automatically adjusts the first threshold based on a battle status. For example, when a camp to which the master virtual character belongs is at a disadvantage, the first threshold may be increased, and when the camp to which the master virtual character belongs is at an advantage, the first threshold may be decreased. In the aspects described herein, through flexible setting of the first threshold, the form of human-computer interaction can be enriched, and it is more friendly to novice players and can also meet the needs of experienced players to further improve the game level. In some other aspects, when the attribute value of the first slave virtual object is equal to a minimum value, the first slave virtual object is to be in an elimination state. However, in the aspects described herein, the first slave virtual object is also considered to be in the unhealthy state in this case.

Specifically, when the attribute value is the health value, assuming that the first threshold is 100, if the health value of the first slave virtual object is less than 100, the first slave virtual object is considered to be in the unhealthy state. In some other aspects, when the attribute value is the health value, assuming that the first threshold is 0, if the health value of the first slave virtual object is equal to 0, the first slave virtual object is considered to be in the unhealthy state.

In some aspects, the unhealthy state is the health value of the first slave virtual object being less than 20 or 20%.

In some aspects, the first threshold is a default value or set by the player. This is not specifically limited in the aspects described herein.

In some aspects, the value of the first threshold is at least one of a fixed value or a percentage, but is not limited thereto. This is not specifically limited in the aspects described herein.

For example, using an example in which the first threshold is a fixed value of 20, in a case that the health value of the first slave virtual object is less than 20, the first slave virtual object is in the unhealthy state. Using an example in which the threshold is a percentage of 20%, in a case that the health value of the first slave virtual object is less than 20%, the first slave virtual object is in the unhealthy state.

For example, in response to the first slave virtual object receiving an attack operation, in a case that the attribute value of the first slave virtual object is less than the first threshold, the computer device displays the first slave virtual object in the unhealthy state.
Operation 406: Display a picture of the first slave virtual object transitioning from the unhealthy state to a healthy state in response to an interaction operation of the master virtual character on a target virtual character.

The target virtual character is a virtual character tamed or defeated or purchased or redeemed by the master virtual character, but is not limited thereto. This is not specifically limited in the aspects described herein.

Specifically, when the target virtual character is a virtual character defeated by the master virtual character, in this case, the master virtual character can be controlled to walk to the target virtual character. When a distance between the master virtual character and the target virtual character is less than a threshold, an interaction control is displayed. A picture of the first slave virtual object transitioning from the unhealthy state to the healthy state is displayed in response to the interaction operation on the interaction control.

In some other aspects, when the target virtual character is a virtual character redeemed or purchased or tamed by the master virtual character, after the virtual character is redeemed or purchased or tamed by the master virtual character, in response to an operation on the target virtual character, the target virtual character is displayed in the virtual environment, the master virtual character is controlled to walk to the target virtual character, and when the distance between the master virtual character and the target virtual character is less than the threshold, the interaction control is displayed. A picture of the first slave virtual object transitioning from the unhealthy state to the healthy state is displayed in response to the interaction operation on the interaction control.

In some other aspects, after the user redeems or purchases the target virtual character by using a virtual resource, the target virtual character is directly displayed in the virtual environment, and in this case, the target virtual character and the master virtual character belong to the same camp. While the target virtual character is displayed, the interaction control is simultaneously displayed within a threshold range near the target virtual character. A picture of the first slave virtual object transitioning from the unhealthy state to the healthy state is displayed in response to the interaction operation on the interaction control.

In some aspects, the displaying a picture of the first slave virtual object transitioning from the unhealthy state to the healthy state may also be understood as directly displaying the first slave virtual object in the healthy state, or displaying a specific transition process of the first slave virtual object from the unhealthy state to the healthy state. For example, in the transition process, a transition text is displayed, or a transition animation is displayed.

In some aspects, the target virtual character is in a corpse state after being defeated by the master virtual character, or the target virtual character is in the unhealthy state after being defeated by the master virtual character.

In some aspects, the target virtual character in the unhealthy state is at least one of kneeling, lying face down, or lying face up on the ground, but is not limited thereto. This is not specifically limited in the aspects described herein.

The interaction operation is a transition operation on the target virtual character by the master virtual character interacting with the target virtual character.

In some aspects, the interaction operation includes a transition operation on the target virtual character by the master virtual character interacting with the target virtual character through a body of the master virtual character, or a transition operation on the target virtual character by a virtual prop interacting with the target virtual character, but is not limited thereto. This is not specifically limited in the aspects described herein. In some aspects, the interaction operation is an operation for transitioning a state of the target virtual character. An operation type of the interaction operation is not limited in this application. The interaction operation may be an operation such as a click operation, a swipe operation, or a press and hold operation on the interaction control. The interaction control is a control on the user interface. A display position and a display style of the control are also not limited in this application. In some aspects, the interaction operation may also be referred to as a spell casting operation. This application does not limit a specific name of the interaction operation.

For example, the master virtual character moves to a vicinity of the target virtual character in the virtual scene, and the computer device regenerates the first slave virtual object from the unhealthy state to the healthy state by using the target virtual character in response to the interaction operation of the master virtual character on the target virtual character.

The healthy state is the attribute value of the first slave virtual object being at a peak (a maximum value), or the healthy state is the attribute value of the first slave virtual object being greater than a second threshold. The attribute value includes, but is not limited to, a health value, a defense value, and an attack value. The second threshold is greater than or equal to the first threshold. In the aspects described herein, the second threshold may be a fixed value preset by a developer, or may be set by the user controlling the master virtual character. For example, during the battle, the user can flexibly set the value of the second threshold based on a real-time battle status. In still some other aspects, the computer device automatically adjusts the second threshold based on a battle status. For example, when a camp to which the master virtual character belongs is at a disadvantage, the second threshold may be increased, and when the camp to which the master virtual character belongs is at an advantage, the second threshold may be decreased. In the aspects described herein, through flexible setting of the second threshold, it can also meet the needs of players of different levels to improve the gaming experience of the user.

In some aspects, when the first threshold is equal to the second threshold, if the attribute value of the first slave virtual object is less than or equal to the first threshold, the first slave virtual object is in the unhealthy state, and if the attribute value of the first slave virtual object is greater than the first threshold, the first slave virtual object is in the healthy state. In some other aspects, when the first threshold is less than the second threshold, if the attribute value of the first slave virtual object is greater than the first threshold and less than or equal to the second threshold, the first slave virtual object is considered to be in an intermediate state, where the intermediate state is a state different from the healthy state or the unhealthy state.

In some aspects, the value of the peak is at least one of a fixed value or a percentage, but is not limited thereto. This is not specifically limited in the aspects described herein.

In some aspects, the healthy state is the health value of the first slave virtual object being 100 or 100%, or the healthy state is the health value of the first slave virtual object being greater than 20 or 20%.

For example, using an example in which the peak is a fixed value of 100, in a case that the health value of the first slave virtual object is 100, the first slave virtual object is in the healthy state. Using an example in which the peak is a percentage of 100%, in a case that the health value of the first slave virtual object is 100%, the first slave virtual object is in the healthy state.

For example, in a case that the first slave virtual object is in the unhealthy state, for example, the health value of the first slave virtual object is less than 20%, the computer device regenerates the health value of the first slave virtual object from 20% to 100% by using the target virtual character in response to the master virtual character performs the interaction operation on the target virtual character, thereby regenerating the first slave virtual object in the unhealthy state.

In conclusion, according to the method provided in this aspect, a master virtual character and a first slave virtual object located in a virtual scene are displayed; the first slave virtual object enters an unhealthy state in response to an attribute value of the first slave virtual object being less than a first threshold; the master virtual character moves to a vicinity of a target virtual character in the virtual scene; and the first slave virtual object is regenerated from the unhealthy state to a healthy state by using the target virtual character in response to an interaction operation of the master virtual character on the target virtual character. This application provides a new manner for restoring a state of a slave virtual object, which can quickly restore the slave virtual object to a healthy state, thereby reducing the game duration and alleviating the processing pressure on the server, further improving the efficiency of human-computer interaction.

FIG. 5 is a flowchart of a control method for a virtual object according to an illustrative aspect described herein. This method may be performed by a terminal device in the system shown in FIG. 3 or a client on the terminal device. The method includes:
Operation 502: Display a master virtual character and a first slave virtual object located in a virtual scene.

The virtual scene is a virtual activity space provided by an application in the terminal device during running, for the master virtual character to perform various activities in the virtual activity space.

For example, a first position of the master virtual character or the first slave virtual object in the virtual scene may be a center position of a map display control, or may be another position in the map display control. That is, the first position of the master virtual character or the first slave virtual object in the virtual scene may correspond to the center of the map display control, or may correspond to another position in the map display control.
Operation 504: Display a picture of the first slave virtual object entering an unhealthy state in response to an attribute value of the first slave virtual object being less than a first threshold.

The unhealthy state is a health value of the first slave virtual object being less than the first threshold.

The first slave virtual object is a movable object with different functions owned by the master virtual character in the virtual scene.

The first slave virtual object may be obtained through at least one of picking up, robbing, and purchasing. This is not limited in this application.
Operation 506: Display the picture of the first slave virtual object transitioning from the unhealthy state to the healthy state in response to the master virtual character transforming attribute information with the target virtual character by using a virtual summon chip.

The target virtual character is a virtual character tamed or defeated or purchases or redeemed by the master virtual character, but is not limited thereto. This is not specifically limited in the aspects described herein.

For example, the master virtual character owns a virtual summon chip for summoning the first slave virtual object. The computer device regenerates the first slave virtual object from the unhealthy state to the healthy state by using the target virtual character in response to the master virtual character transforming attribute information with the target virtual character by using the virtual summon chip. The virtual summon chip is a virtual prop configured for summoning the first slave virtual object. A specific style of the virtual summon chip is not limited in this application.

The virtual summon chip is configured for summoning a slave virtual object in the healthy state to enter an independent form or an attached form.

In some aspects, the form of the slave virtual object includes: at least one of a backpack form, an attached form, or an independent form, but is not limited thereto. This is not specifically limited in the aspects described herein.

The backpack form is a state in which the slave virtual object is in an inactive state and is placed in a backpack in a form of a chip.

The attached form is a state in which the slave virtual object is in an inactive state, and the slave virtual object is attached to a body part of the master virtual character to become a part of the master virtual character.

The independent form is a state in which the slave virtual object is in an inactive state and the slave virtual object acts independently of the master virtual character.

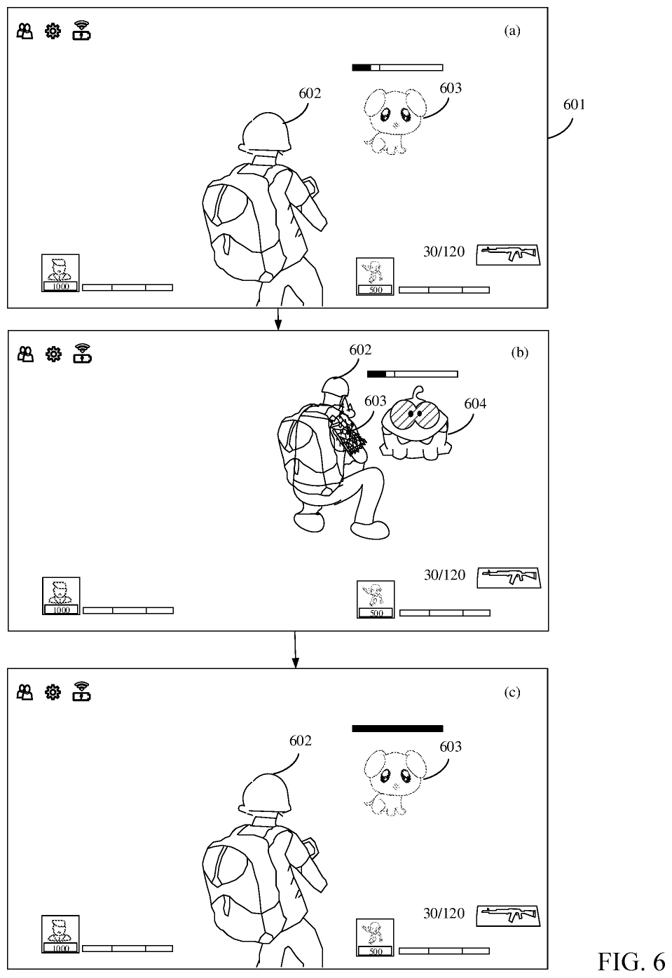

For example, FIG. 6 is a schematic diagram of a control method for a virtual object. As shown in (a) of FIG. 6, a virtual environment picture 601 is displayed on the user interface. The virtual environment picture 601 includes a master virtual character 602 and a first slave virtual object 603 of the master virtual character 602. As shown in (b) of FIG. 6, after the first slave virtual object 603 enters an unhealthy state, the first slave virtual object 603 is automatically attached to a body part of the master virtual character 602 for automatic recovery. A target virtual character 604 is displayed in (b), and the master virtual character 602 moves to a vicinity of the target virtual character 604 in the virtual scene. As shown in (c) of FIG. 6, the computer device regenerates the first slave virtual object 603 from the unhealthy state to a healthy state by using the target virtual character 604 in response to an interaction operation of the master virtual character 602 on the target virtual character 604.

In some aspects, the attribute information includes attribute value information and skill information. The attribute value information includes at least one attribute value above, and the skill information is information about a skill that can be cast by the virtual object.

For example, the computer device regenerates the health value of the first slave virtual object from a state less than the first threshold to a peak state based on the target virtual character in response to the master virtual character transforming the health value information with the target virtual character by using the virtual summon chip.

For example, in a case that the first slave virtual object is in the healthy state, the virtual summon chip may be configured for summoning the slave virtual object in the healthy state to enter the independent form or the attached form. In a case that the first slave virtual object is in the unhealthy state, for example, the health value of the first slave virtual object is less than 20%, the computer device regenerates the health value of the first slave virtual object from 20% to 100% based on the target virtual character in response to the master virtual character transforming the health value information with the target virtual character by using the virtual summon chip.

For example, the computer device regenerates the first slave virtual object from the unhealthy state to the healthy state based on the target virtual character in response to the master virtual character transforming the skill information with the target virtual character by using the virtual summon chip, and the first slave virtual object inherits a skill of the target virtual character.

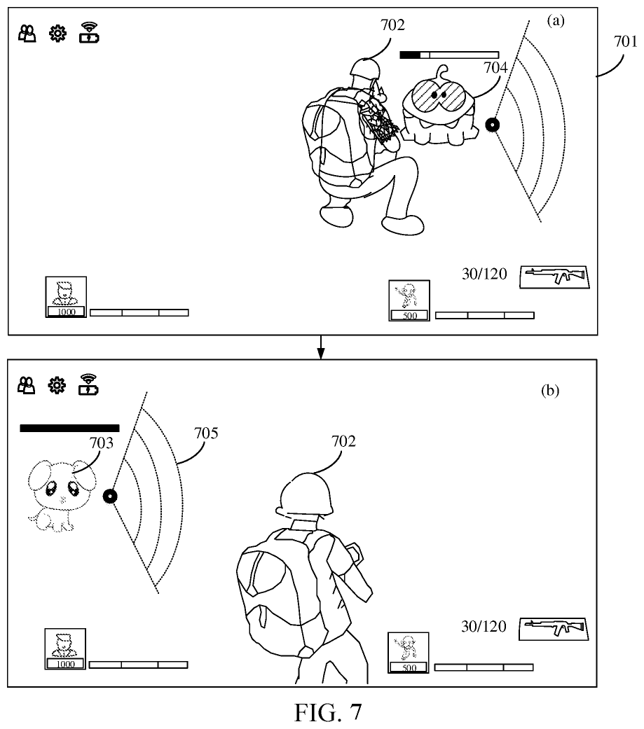

For example, FIG. 7 is a schematic diagram of a virtual object inheriting a skill of a target virtual character. As shown in (a) of FIG. 7, a virtual environment picture 701 is displayed on the user interface, the virtual environment picture 701 includes a master virtual character 702 and a target virtual character 704, the target virtual character 704 has an exploration skill 705, and the master virtual character 702 moves to a vicinity of the target virtual character 704 in the virtual scene. As shown in (b) of FIG. 7, the computer device regenerates the first slave virtual object 703 from the unhealthy state to the healthy state by using the target virtual character 704 in response to an interaction operation of the master virtual character 702 on the target virtual character 704, and the first slave virtual object 703 inherits a skill of the target virtual character 704, that is, the first slave virtual object 703 transitioning to the healthy state also has the exploration skill 705.

In some aspects, the computer device regenerates the first slave virtual object from the unhealthy state to the healthy state based on the target virtual character in response to the master virtual character transforming the skill information with the target virtual character by using the virtual summon chip, and the first slave virtual object carries both a first skill and a second skill.

The first skill is a skill unique to the first slave virtual object, and the second skill is a skill unique to the target virtual character.

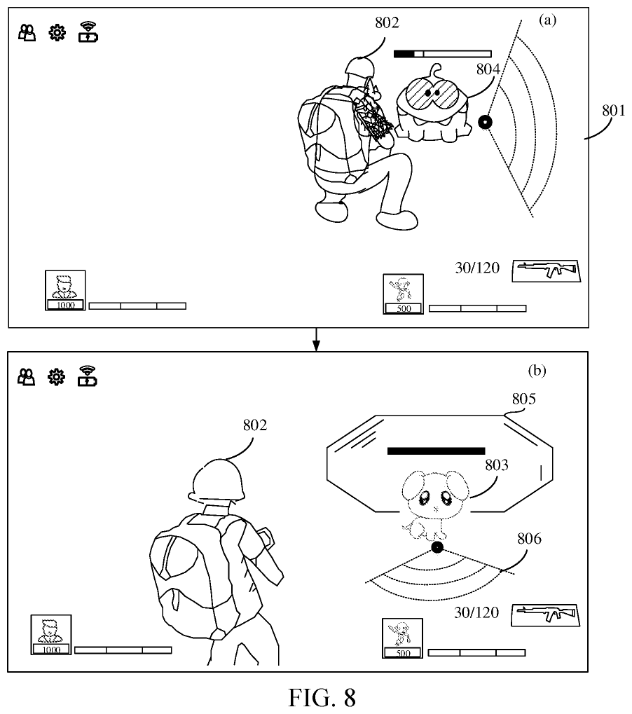

For example, FIG. 8 is a schematic diagram of a virtual object inheriting a skill of a target virtual character. As shown in (a) of FIG. 8, a virtual environment picture 801 is displayed on the user interface, the virtual environment picture 801 includes a master virtual character 802 and a target virtual character 804, the target virtual character 804 has an exploration skill 806, and the master virtual character 802 moves to a vicinity of the target virtual character 804 in the virtual scene. As shown in (b) of FIG. 8, the first slave virtual object 803 carries a shield skill 805. The computer device regenerates the first slave virtual object 803 from the unhealthy state to the healthy state by using the target virtual character 804 in response to an interaction operation of the master virtual character 802 on the target virtual character 804, and the first slave virtual object 803 inherits skills of both the first slave virtual object 803 and the target virtual character 804, that is, the first slave virtual object 803 transitioning to the healthy state has both the exploration skill 806 and the shield skill 805.

In some aspects, the computer device displays a picture of the first slave virtual object transitioning from the unhealthy state to the healthy state in response to the master virtual character transforming the skill information with the target virtual character by using the virtual summon chip, and the first slave virtual object obtains a third skill.

The third skill is regenerated by fusing a first skill and a second skill; and the first skill is a skill unique to the first slave virtual object, and the second skill is a skill unique to the target virtual character.

For example, attribute information of the first skill and attribute information of the second skill are obtained; and skill fusion is performed on the first skill and the second skill based on an attribute association relationship between the first skill and the second skill, to obtain the third skill.

For example, if the first skill is a skill with a “wood” attribute, and the second skill is a skill with a “fire” attribute, the computer device performs skill fusion on the first skill and the second skill based on an attribute association relationship between the first skill and the second skill, to obtain the third skill, where the third skill is a skill with a “gold” attribute. For example, when the master virtual character casts the first skill, a wooden prisoner cage appears, and may be configured for trapping the target virtual character or the opponent virtual character in the wooden prisoner cage. When the master virtual character casts the first skill, the master virtual character ejects a fireball. In a case that the master virtual character owns and uses the third skill, a metal prisoner cage burning in flames appears.

In some aspects, the attribute association relationship includes a reduction relationship and an enhancement relationship. The computer device performs skill fusion on the first skill and the second skill based on a reduction relationship between attribute relationships of the first skill and the second skill, to obtain a third skill, and a skill effect of the third skill is weaker than a skill effect of any one of the first skill and the second skill. The computer device performs skill fusion on the first skill and the second skill based on an enhancement relationship between the attribute relationships of the first skill and the second skill, to obtain a third skill, and a skill effect of the third skill is weaker than a combined skill effect of the first skill and the second skill.

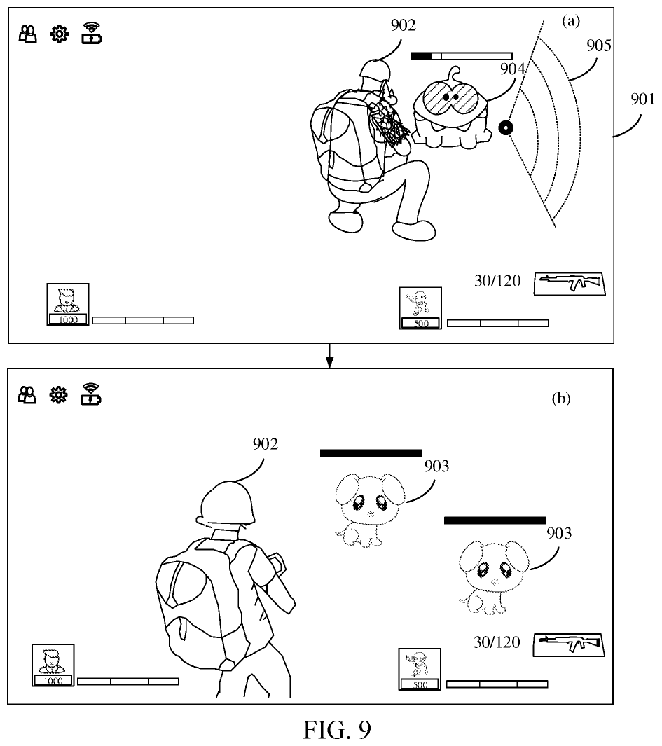

For example, FIG. 9 is a schematic diagram of a virtual object inheriting a skill of a target virtual character. As shown in (a) of FIG. 9, a virtual environment picture 901 is displayed on the user interface, the virtual environment picture 901 includes a master virtual character 902 and a target virtual character 904, the target virtual character 904 has an exploration skill 905, and the master virtual character 902 moves to a vicinity of the target virtual character 904 in the virtual scene. As shown in (b) of FIG. 9, the first slave virtual object 903 carries a shield skill. The computer device regenerates the first slave virtual object 903 from the unhealthy state to the healthy state by using the target virtual character 904 in response to an interaction operation of the master virtual character 902 on the target virtual character 904, and the first slave virtual object 903 inherits a skill generated by fusing skills of the first slave virtual object 903 and the target virtual character 904: a clone skill. As shown in (b) of FIG. 9, after the first slave virtual object 903 inherits the skills of the first slave virtual object 903 and the target virtual character 904, a new clone skill is generated, and two first slave virtual objects 903 are displayed.

In some aspects, the master virtual character further owns a second slave virtual object, and the computer device switches the first slave virtual object in the attached form to the second slave virtual object in response to a switching operation on the slave virtual object, and displays a picture of the first slave virtual object in the attached form switching to the second slave virtual object. In some aspects, the second slave virtual object and the first slave virtual object are both slave virtual objects of the master virtual character.

For example, the computer device switches the first slave virtual object attached to the body part of the master virtual character to the second slave virtual object in response to the switching operation on the slave virtual object, and the second slave virtual object inherits the health value of the first slave virtual object based on a health value percentage, and displays a picture of the first slave virtual object attached to the body part of the master virtual character switching to the second slave virtual object. In some aspects, the switching operation is an operation for switching the slave virtual object. An operation type of the switching operation is not limited in this application. The switching operation may be an operation such as a click operation, a swipe operation, or a press and hold operation on a switching control. The switching control is a control on the user interface. A display position and a display style of the control are also not limited in this application.

The health value percentage is a ratio of a current health value of the first slave virtual object to a total health value of the first slave virtual object.

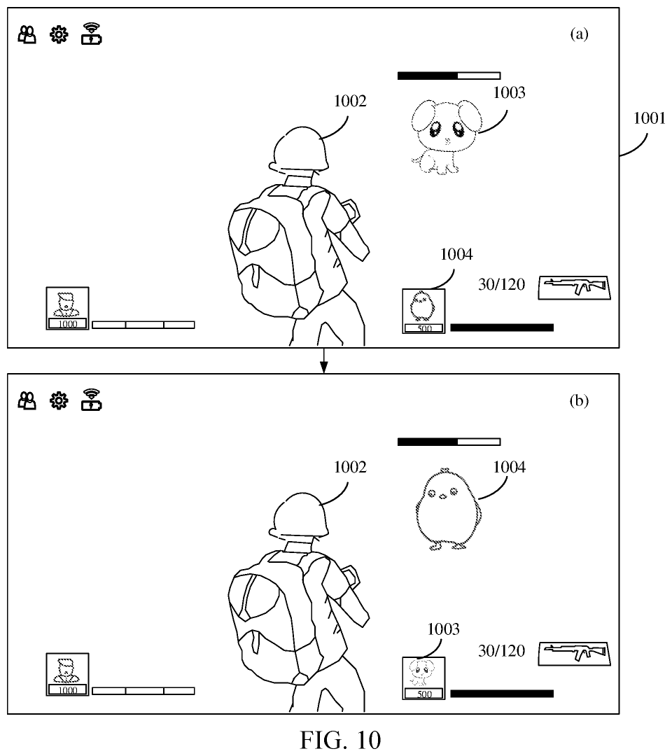

For example, FIG. 10 is a schematic diagram of switching a virtual object. As shown in (a) of FIG. 10, a virtual environment picture 1001 is displayed on the user interface. The virtual environment picture 1001 includes a master virtual character 1002, a first slave virtual object 1003 of the master virtual character 1002, and a second slave virtual object 1004 of the master virtual character 1002. A health value of the first slave virtual object 1003 is 50%, and a health value of the second slave virtual object 1004 is 100%. The computer device switches the first slave virtual object 1003 to the second slave virtual object 1004 in response to the switching operation on the slave virtual object, and the second slave virtual object 1004 inherits the health value of the first slave virtual object 1003 based on the health value percentage. As shown in (b) of FIG. 10, the health value of the second slave virtual object 1004 changes to 50%, and the health value of the first slave virtual object 1003 changes to 100%.

For example, in a case that the first slave virtual object in the attached form is in the unhealthy state, the computer device switches the first slave virtual object attached to the body part of the master virtual character to the second slave virtual object in response to the switching operation on the slave virtual object, and the second slave virtual object is in the unhealthy state.

For example, if the total health value of the first slave virtual object is 1000, the health value of the first slave virtual object in the unhealthy state is 200, and the total health value of the second slave virtual object is 2000, the computer device responds to the switching operation on the slave virtual object, the second slave virtual object inherits the health value of the first slave virtual object based on the health value percentage, and the health value of the second slave virtual object after switching is 400.

In some aspects, the computer device displays a picture of the first slave virtual object switching from a first form to a second form in response to the attribute value of the first slave virtual object being less than the first threshold and the first slave virtual object entering the unhealthy state.

The first form (also referred to as an independent form) is a form in which the first slave virtual object acts independently of the master virtual character, or may be understood as a form in which a character range of the first slave virtual object and a character range of the master virtual character do not intersect.

The second form (also referred to as an attached form) is a form in which the first slave virtual object is attached to a body part of the master virtual character to become a part of the master virtual character, or may be understood as a form in which there is an overlapping region between the character range of the first slave virtual object and the character range of the master virtual character.

In some aspects, the attribute value includes at least one of a health value (or referred to as a blood volume value) and a skill value, but is not limited thereto. This is not specifically limited in the aspects described herein.

For example, in a case that the first slave virtual object is attacked and a blood volume value of the first slave virtual object is less than 20%, the first slave virtual object enters the unhealthy state, and the first slave virtual object is automatically attached to an arm of the master virtual character for self-recovery.

In some aspects, the computer device displays a recovery progress bar in response to the first slave virtual object in the unhealthy state switching from the first form to the second form.

The recovery progress bar is configured for representing a recovery progress of the first slave virtual object in the unhealthy state, and when the recovery progress bar is full, the first slave virtual object transitions from the unhealthy state to the healthy state.

For example, in a case that the first slave virtual object enters the unhealthy state and the first slave virtual object is automatically attached to the arm of the master virtual character for self-recovery, the recovery progress bar is displayed. When the recovery progress bar is full, the first slave virtual object transitions from the unhealthy state to the healthy state.

In some aspects, the computer device automatically switches the first slave virtual object from the second form to the first form after the first slave virtual object transitions from the unhealthy state to the healthy state.

For example, in a case that the first slave virtual object enters the unhealthy state, and the first slave virtual object is automatically attached to the arm of the master virtual character for self-recovery, after the first slave virtual object transitions from the unhealthy state to the healthy state, the first slave virtual object automatically disengages from the arm of the master virtual character to an independent form.

In some aspects, the computer device displays a picture of the first slave virtual object freely switching between the first form and the second form in response to a form switching operation on the first slave virtual object in the healthy state.

The first slave virtual object in the first form can lock and/or attack the target virtual character; and the first slave virtual object in the second form can increase an attribute value of the master virtual character. For example, a defense value is increased.

For example, the first slave virtual object in the healthy state can switch between the attached form and the independent form at any time. The first slave virtual object in the attached form can increase an attribute value of the master virtual character, for example, increase an attack value and a defense value. The first slave virtual object in the independent form can lock and/or attack the target virtual character.

In conclusion, according to the method provided in this aspect, a master virtual character and a first slave virtual object located in a virtual scene are displayed; the first slave virtual object enters an unhealthy state in response to an attribute value of the first slave virtual object being less than a first threshold; and the first slave virtual object is regenerated from the unhealthy state to a healthy state by using the target virtual character in response to an interaction operation of the master virtual character on the target virtual character. This application provides a new manner for restoring a state of a slave virtual object, which can quickly restore the slave virtual object to a healthy state, thereby reducing the game duration and alleviating the processing pressure on the server, further improving the efficiency of human-computer interaction and improving the user experience.

In the method provided in this aspect, the master virtual character is controlled to use the virtual summon chip and the target virtual character to transform the attribute information, and the first slave virtual object is regenerated from the unhealthy state to the healthy state by using the target virtual character. This application provides a new manner for restoring a state of a slave virtual object, which can quickly restore the slave virtual object to the healthy state by using the target virtual character through the virtual summon chip for summoning the slave virtual object, thereby reducing the game duration and alleviating the processing pressure on the server, further improving the efficiency of human-computer interaction and improving the user experience.

In the method provided in this aspect, the attribute information includes the skill information, and the skill information is transformed with the target virtual character through the virtual summon chip, to quickly restore the slave virtual object to the healthy state, thereby reducing the game duration and alleviating the processing pressure on the server, further improving the efficiency of human-computer interaction and improving the user experience. Further, in a case that the first slave virtual object is regenerated from the unhealthy state to the healthy state, the first slave virtual object obtains the first skill and the second skill, or the first slave virtual object obtains the third skill obtained by fusing the first skill and the second skill. Therefore, the aspects described herein further provide a new skill generation and display manner. The third skill is obtained by fusing the first skill and the second skill, which is conducive to enriching the form of human-computer interaction and improving the gaming experience of the user.

In the method provided in this aspect, the first slave virtual object in the healthy state can freely switch between the first form and the second form. The first slave virtual object in different forms can implement different functions, which enriches game modes and improves the user experience.

In the method provided in this aspect, when the first slave virtual object is in the unhealthy state, the first slave virtual object automatically switches to the second form, and the recovery progress bar is displayed. The recovery progress bar directly displays the recovery progress of the first slave virtual object. When the recovery progress bar is full, the first slave virtual object transitions from the unhealthy state to the healthy state. After the first slave virtual object transitions from the unhealthy state to the healthy state, the first slave virtual object automatically switches from the second form to the first form, which enriches the game modes and improves the user experience.

In the method provided in this aspect, in response to the form switching operation on the first slave virtual object in the healthy state, the first slave virtual object can freely switch between the first form and the second form. The player can switch the form of the first slave virtual object according to an actual environment, which enriches the game modes and improves the user experience.

In the method provided in this aspect, the health value of the switched object is inherited based on the health value percentage in the process of switching the slave virtual object, which provides a new game switching mode, and improves the user experience.

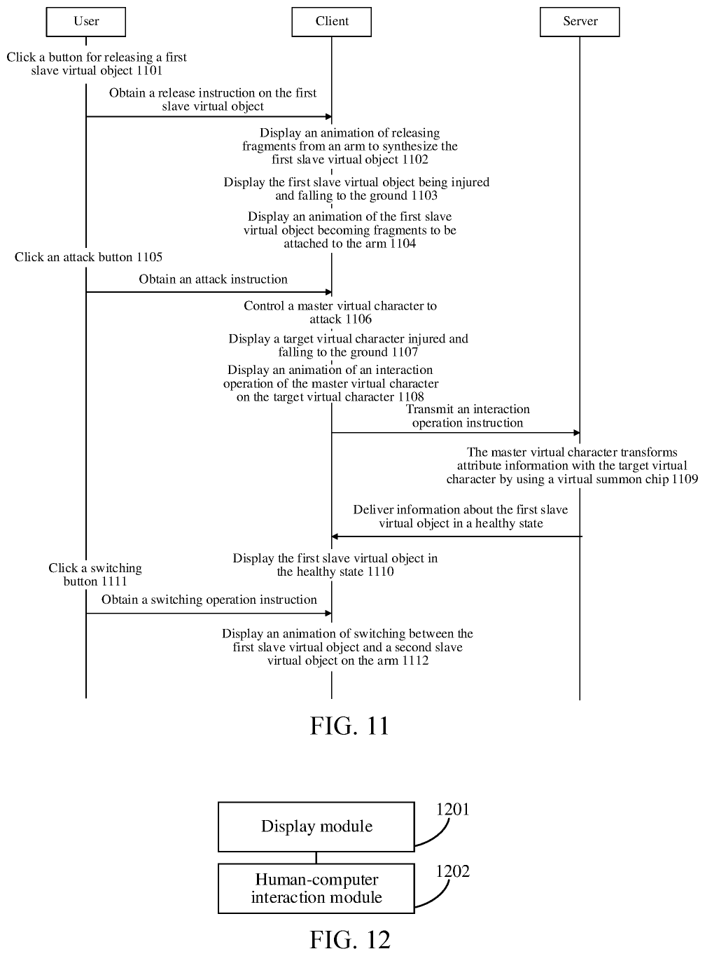

FIG. 11 is a flowchart of a control method for a virtual object according to an illustrative aspect described herein. The method includes:
Operation 1101: Click a button for releasing a first slave virtual object.

For example, in a virtual scene, a master virtual character may own at least one virtual summon chip. The virtual summon chip may be configured for summoning the first slave virtual object, display the first slave virtual object as an attached form or an independent form, or retract the first slave virtual object in the attached form or the independent form to a backpack form. The first slave virtual object and the master virtual character have a master-slave relationship.

In some aspects, the first slave virtual object is obtained by purchasing or by defeating any target virtual character in the virtual scene, and the target virtual character is collected as the first slave virtual object through the virtual summon chip.

For example, the master virtual character defeats any target virtual character in the virtual scene, and controls the target virtual character through the virtual summon chip, to determine the master-slave relationship with the target virtual character.

In some aspects, the form of the slave virtual object includes: at least one of a backpack form, an attached form, or an independent form, but is not limited thereto. This is not specifically limited in the aspects described herein.

The backpack form is a state in which the slave virtual object is in an inactive state and is placed in a backpack in a form of a chip.

The attached form is a state in which the slave virtual object is in an inactive state, and the slave virtual object is attached to a body part of the master virtual character to become a part of the master virtual character.

The independent form is a state in which the slave virtual object is in an inactive state and the slave virtual object acts independently of the master virtual character.

For example, the user clicks a button for summoning the “first slave virtual object”, and a client obtains a “first slave virtual object” summon instruction.

In some aspects, the type of the first slave virtual object includes at least one of a crusher slave virtual object, a guardian slave virtual object, a suppressor slave virtual object, and a seer slave virtual object, but is not limited thereto.

The crusher slave virtual object is configured for melee disruption, the guardian slave virtual object is configured for shield defense, the suppressor slave virtual object is configured for long-range melee shooting, and the seer slave virtual object is configured for reconnaissance and scanning assistance.
Operation 1102: Display an animation of releasing fragments from an arm to synthesize the first slave virtual object.

For example, in a case that the client obtains the “first slave virtual object” summon instruction, an animation of the “first slave virtual object” being attached to the arm of the master virtual character is displayed on a user interface of the client.

In some aspects, the animation of the “first slave virtual object” being attached to the arm of the master virtual character is a process of the “first slave virtual object” being attached to the arm of the master virtual character, or a special effect display obtained after the “first slave virtual object” is attached to the arm of the master virtual character. This is not limited in the aspects described herein.
Operation 1103: Display the first slave virtual object being injured and falling to the ground.

For example, after the first slave virtual object is attacked, a picture of the first slave virtual object being injured and falling to the ground is displayed.
Operation 1104: Display an animation of the first slave virtual object becoming fragments to be attached to the arm.

For example, after the first slave virtual object is injured and falls to the ground, the first slave virtual object is automatically attached to the arm of the master virtual character for self-recovery.

For example, the first slave virtual object is automatically attached to the arm of the master virtual character and restores to the healthy state after 2 minutes of recovery.
Operation 1105: Click an attack button.

For example, the user clicks an attack button, and the client obtains an attack instruction.
Operation 1106: Control a master virtual character to attack.

For example, the client controls the master virtual character to attack a target virtual object in the virtual scene.
Operation 1107: Display the target virtual character injured and falling to the ground.

For example, after the target virtual object in the virtual scene is defeated, the target virtual character injured and falling to the ground is displayed.
Operation 1108: Display an animation of an interaction operation of the master virtual character on the target virtual character.

For example, the master virtual character moves to a vicinity of the target virtual character in the virtual scene, the interaction operation of the master virtual character on the target virtual character is displayed, and the client obtains an interaction operation instruction.

In some aspects, the interaction operation includes a transition operation performed by the master virtual character on the target virtual character by using a body of the master virtual character, or a transition operation performed on the target virtual character by using a virtual summon prop, but is not limited thereto. This is not specifically limited in the aspects described herein.

For example, when the master virtual character moves to the vicinity of the target virtual character in the virtual scene, the master virtual character inserts the virtual summon prop into the body of the target virtual character, and an animation of the target virtual character transitioning to the first slave virtual object is displayed.
Operation 1109: The master virtual character transforms attribute information with the target virtual character by using a virtual summon chip.

For example, the master virtual character transforms the attribute information with the target virtual character by using the virtual summon chip, regenerates the first slave virtual object from the unhealthy state to the healthy state by using the target virtual character, and delivers information about the first slave virtual object in the healthy state.
Operation 1110: Display the first slave virtual object in the healthy state.

For example, after the information about the first slave virtual object in the healthy state is received, the first slave virtual object in the healthy state is displayed.
Operation 1111: Click a switching button.

For example, the user clicks the switching button, and the client obtains a switching operation instruction.
Operation 1112: Display an animation of switching between the first slave virtual object and a second slave virtual object on the arm.

For example, after the switching operation instruction is received, the animation of switching between the first slave virtual object and the second slave virtual object is displayed on the arm.

For example, the first slave virtual object is currently on the arm of the master virtual character in the attached form, and the second slave virtual object is on the arm of the master virtual character in the attached form in response to the switching operation.

For example, the computer device switches the first slave virtual object attached to the body part of the master virtual character to the second slave virtual object in response to the switching operation on the slave virtual object, and the second slave virtual object inherits a health value of the first slave virtual object based on a health value percentage.

For example, the health value of the first slave virtual object is 50%, and the health value of the second slave virtual object is 100%. The computer device switches the first slave virtual object to the second slave virtual object in response to the switching operation on the slave virtual object, and the second slave virtual object inherits the health value of the first slave virtual object based on the health value percentage. In other words, the health value of the second slave virtual object changes to 50%, and the health value of the first slave virtual object changes to 100%.

In another example, if the total health value of the first slave virtual object is 1000, the health value of the first slave virtual object in the unhealthy state is 200, the total health value of the second slave virtual object is 2000, and the health value of the second slave virtual object is 2000, the computer device responds to the switching operation on the slave virtual object, the second slave virtual object inherits the health value of the first slave virtual object based on the health value percentage, and the health value of the second slave virtual object after switching is 400.

For example, at the beginning of the game, the master virtual character obtains a nanochip, and the obtained nanochip is configured for core control of the slave virtual object. After obtaining the nanochip, the master virtual character defeats any target virtual character to the ground or kills any target virtual character in the virtual scene, and the master virtual character performs a core control operation on the target virtual character by using the nanochip, to transform the target virtual character to the slave virtual object. During the core control operation, a wheel is displayed on the nanochip, and the wheel is configured for determining an attribute of the slave virtual object transformed by the target virtual character.

In some aspects, the nanochip may be obtained by at least one of picking up or searching a treasure box, but is not limited thereto. This is not specifically limited in the aspects described herein.

The master virtual character and the slave virtual object have a master-slave relationship. In some aspects, the slave virtual object is obtained by purchasing, or by defeating any target virtual character in the virtual scene, the target virtual character is collected as the slave virtual object through the nanochip.

If any interference occurs during the core control operation, the core control operation process is interrupted. After the core control operation is completed, the slave virtual object is attached to the arm of the master virtual character in the attached form, and a crystallization effect is displayed on the arm of the master virtual character. The slave virtual object in the attached form can provide benefits to the attribute or skill of the master virtual character. In addition, the master virtual character may summon the slave virtual object in the attached form to act in the independent form. The slave virtual object in the independent form can attack or lock an opponent virtual character.

In a case that the master virtual character owns two slave virtual objects, the animation of switching between the first slave virtual object and the second slave virtual object is displayed on the arm of the master virtual character by clicking the switching button.

For example, when the slave virtual object in the independent form is attacked, a blood volume of the slave virtual object correspondingly decreases. In a case that the blood volume is zero or the blood volume is less than the first threshold, the slave virtual object enters the unhealthy state, and the slave virtual object automatically switches from the independent form to the attached form for self-recovery. In this case, the slave virtual object in the attached form does not provide benefits to the attribute or skill of the master virtual character until self-recovery of the slave virtual object is completed. For example, after 2 minutes of self-recovery, the slave virtual object restores to the independent form.

For example, when the slave virtual object in the independent form is attacked, in a case that the blood volume is zero or the blood volume is less than the first threshold, the slave virtual object enters the unhealthy state, and the slave virtual object automatically switches from the independent form to the attached form for self-recovery. In this case, the master virtual character performs the interaction operation on the target virtual character by using the nanochip, and regenerates the slave virtual object from the unhealthy state to the healthy state by using the target virtual character, and the slave virtual object restores to the independent form.

In conclusion, this application provides a new manner for restoring a state of a slave virtual object, which can quickly restore the slave virtual object to a healthy state, thereby reducing the game duration and alleviating the processing pressure on the server, further improving the efficiency of human-computer interaction and improving the user experience.

FIG. 12 is a schematic structural diagram of a control apparatus for a virtual object according to an illustrative aspect described herein. The apparatus may be implemented as all or part of a computer device by using software, hardware, or a combination thereof. The apparatus includes:
a display module 1201, configured to display a master virtual character and a first slave virtual object located in a virtual scene, the master virtual character and the first slave virtual object having a master-slave relationship; and
a human-computer interaction module 1202, configured to display a picture of the first slave virtual object entering an unhealthy state in response to an attribute value of the first slave virtual object being less than a first threshold,
the human-computer interaction module 1202 being configured to display a picture of the first slave virtual object transitioning from the unhealthy state to a healthy state in response to an interaction operation of the master virtual character on a target virtual character, the target virtual character being a virtual character redeemed or defeated by the master virtual character.

In some aspects, the master virtual character owns a virtual summon chip for summoning the first slave virtual object; and the display module 1201 is further configured to display the picture of the first slave virtual object transitioning from the unhealthy state to the healthy state in response to the master virtual character transforming attribute information with the target virtual character by using the virtual summon chip.

In some aspects, the attribute information includes skill information; and the human-computer interaction module 1202 is configured to display the picture of the first slave virtual object transitioning from the unhealthy state to the healthy state in response to the master virtual character transforming the skill information with the target virtual character by using the virtual summon chip, the first slave virtual object in the healthy state inheriting a skill of the target virtual character.

In some aspects, the first slave virtual object in the healthy state inheriting a skill of the target virtual character includes: the first slave virtual object in the healthy state carrying both a first skill and a second skill, where
the first skill is a skill unique to the first slave virtual object, and the second skill is a skill unique to the target virtual character.

In some aspects, the first slave virtual object in the healthy state inheriting a skill of the target virtual character includes: the first slave virtual object in the healthy state obtaining a third skill, where
the third skill is regenerated by fusing a first skill and a second skill; and the first skill is a skill unique to the first slave virtual object, and the second skill is a skill unique to the target virtual character.

In some aspects, the human-computer interaction module 1202 is configured to display a picture of the first slave virtual object switching from a first form to a second form in response to the attribute value of the first slave virtual object being less than the first threshold and the first slave virtual object entering the unhealthy state, where
the first form is a form in which the first slave virtual object acts independently of the master virtual character, and the second form is a form in which the first slave virtual object is attached to a body part of the master virtual character to become a part of the master virtual character.

In some aspects, the display module 1201 is configured to display a recovery progress bar in response to the first slave virtual object in the unhealthy state switching from the first form to the second form, where
the recovery progress bar is configured for representing a recovery progress of the first slave virtual object in the unhealthy state, and when the recovery progress bar is full, the first slave virtual object transitions from the unhealthy state to the healthy state.

In some aspects, the human-computer interaction module 1202 is configured to display a picture of the first slave virtual object switching from the second form to the first form after the first slave virtual object transitions from the unhealthy state to the healthy state.

In some aspects, the human-computer interaction module 1202 is configured to display a picture of the first slave virtual object freely switching between the first form and the second form in response to a form switching operation on the first slave virtual object in the healthy state, where
the first slave virtual object in the first form locks and/or attacks the target virtual character; and the first slave virtual object in the second form increases an attribute value of the master virtual character.

In some aspects, the human-computer interaction module 1202 is configured to display a picture of the first slave virtual object in an attached form switching to the second slave virtual object in response to a switching operation on a slave virtual object, where
the attached form is a state in which the slave virtual object is attached to a body part of the master virtual character to become a part of the master virtual character.

In some aspects, the human-computer interaction module 1202 is configured to display a picture of the first slave virtual object attached to the body part of the master virtual character switching to the second slave virtual object in response to the switching operation on the slave virtual object, and the second slave virtual object inherits a health value of the first slave virtual object based on a health value percentage, where
the health value percentage is a ratio of a current health value of the first slave virtual object to a total health value of the first slave virtual object.

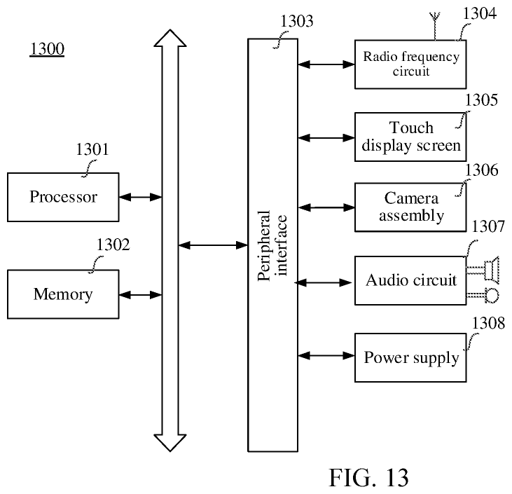

FIG. 13 is a structural block diagram of a computer device 1300 according to an illustrative aspect described herein. The computer device 1300 may be a portable mobile terminal device, such as: a smartphone, a tablet computer, a moving picture experts group audio layer III (MP3) player, or a moving picture experts group audio layer IV (MP4) player. The computer device 1300 may be further referred to as another name such as a user equipment or a portable terminal device.

Usually, the computer device 1300 includes: a processor 1301 and a memory 1302.

The processor 1301 may include one or more processing cores, such as a 4-core processor or an 8-core processor. The processor 1301 may be implemented by using at least one hardware form of a digital signal processing (DSP), a field programmable gate array (FPGA), and a programmable logic array (PLA). The processor 1301 may also include a main processor and a coprocessor. The main processor is configured to process data in an active state, also referred to as a central processing unit (Central Processing Unit, CPU). The coprocessor is a low-power consumption processor configured to process data in a standby state. In some aspects, the processor 1301 may be integrated with a graphics processing unit (GPU). The GPU is configured to be responsible for rendering and drawing content that needs to be displayed in a display. In some aspects, the processor 1301 may alternatively include an artificial intelligence (AI) processor. The AI processor is configured to process a computing operation related to machine learning.

The memory 1302 may include one or more computer-readable storage media. The computer-readable storage medium may be tangible and non-transitory. The memory 1302 may also include a high-speed random access memory (RAM), and a non-volatile memory, for example, one or more disk storage devices and flash storage devices. In some aspects, the non-transitory computer-readable storage medium in the memory 1302 is configured to store at least one instruction. The at least one instruction is executed by the processor 1301 to perform the control method for a virtual object provided in the aspects described herein.

In some aspects, the computer device 1300 may further include: a peripheral interface 1303 and at least one peripheral device. Specifically, the peripheral device includes: at least one of a radio frequency circuit 1304, a touch display screen 1305, a camera 1306, an audio circuit 1307, and a power supply 1308.

A person skilled in the art may understand that the structure shown in FIG. 13 does not constitute any limitation on the computer device 1300, and the computer device 1300 may include more components or fewer components than those shown in the figure, or some components may be combined, or a different component deployment may be used.

An aspect described herein further provides a terminal device. The terminal device includes: a processor and a memory, the memory having a computer program stored therein, and the computer program being loaded and executed by the processor to implement the control method for a virtual object according to the foregoing method aspects.

An aspect described herein further provides a computer-readable storage medium, the computer-readable storage medium having a computer program stored therein, and the computer program being loaded and executed by a processor to implement the control method for a virtual object according to the foregoing method aspects.

An aspect described herein further provides a computer program product, the computer program product including a computer program, the computer program being stored in a computer-readable storage medium; and the computer program being read and executed by a processor of a terminal device from the computer-readable storage medium, causing the terminal device to perform the control method for a virtual object according to the foregoing method aspects.

“A plurality of” mentioned in this specification refers to two or more. “And/or” describes an association relationship between associated objects and represents that three relationships may exist. For example, A and/or B may represent the following three cases: Only A exists, both A and B exist, and only B exists. The character “/” generally represents an “or” relationship between the associated objects.

A person of ordinary skill in the art may understand that all or some of the operations of the foregoing aspects may be implemented by using hardware, or may be implemented by a program instructing relevant hardware. The program may be stored in a computer-readable storage medium. The storage medium may be a ROM, a magnetic disk, an optical disc, or the like.

The foregoing descriptions are merely illustrative aspects described herein, but are not intended to limit this application. Any modification, equivalent replacement, or improvement made within the spirit and principle of this application shall fall within the protection scope of this application.

What is claimed is:

1. A method comprising:
outputting for display on a display device, a master virtual character and a first slave virtual object located in a virtual scene;
determining an attribute value of the first slave virtual object being less than a first threshold;
responsive to the determining, establishing the first slave virtual object to be in an unhealthy state; and
receiving user input initiating an interaction operation of the master virtual character on a target virtual character, the target virtual character being a virtual character redeemed or defeated by the master virtual character;
transitioning the first slave virtual object from the unhealthy state to a healthy state in response to the user input.

2. The method according to claim 1, wherein the master virtual character is associated with a virtual summon chip for summoning the first slave virtual object; and
wherein the received user input uses the virtual summon chip.

3. The method according to claim 2, wherein the attribute information comprises skill information; and the method further comprises:
inheriting a skill of the target virtual character by the first slave virtual object.

4. The method according to claim 3, wherein upon the first slave virtual object in the healthy state inheriting the skill of the target virtual character, the first slave virtual object in the healthy state carries both a first skill and a second skill, wherein the first skill is a skill unique to the first slave virtual object, and the second skill is a skill unique to the target virtual character.

5. The method according to claim 3, wherein upon the first slave virtual object in the healthy state inheriting the skill of the target virtual character, the first slave virtual object in the healthy state obtains a third skill, wherein the third skill is based on fusing a first skill and a second skill, wherein the first skill is a skill unique to the first slave virtual object, and the second skill is a skill unique to the target virtual character.

6. The method according to claim 1, further comprising:
switching the first slave virtual object from a first form to a second form in response to the attribute value of the first slave virtual object being less than the first threshold and the first slave virtual object entering the unhealthy state,
wherein the first form is a form in which the first slave virtual object acts independently of the master virtual character, and the second form is a form in which the first slave virtual object is attached to a body part of the master virtual character to become a part of the master virtual character.

7. The method according to claim 6, wherein the method further comprises:
displaying a recovery progress bar in response to the first slave virtual object in the unhealthy state switching from the first form to the second form,
wherein the recovery progress bar is configured for representing a recovery progress of the first slave virtual object in the unhealthy state, and when the recovery progress bar is full, the first slave virtual object transitions from the unhealthy state to the healthy state.

8. The method according to claim 7, wherein the method further comprises:
displaying the first slave virtual object switching from the second form to the first form after the first slave virtual object transitions from the unhealthy state to the healthy state.

9. The method of claim 6, further comprising:
displaying a picture of the first slave virtual object switching between the first form and the second form in response to receiving user input triggering a form switching operation on the first slave virtual object in the healthy state,
wherein the first slave virtual object in the first form is available to attack the target virtual character; and the first slave virtual object in the second form increases an attribute value of the master virtual character.

10. The method of claim 1, wherein the master virtual character is associated with a second slave virtual object; and the method further comprises:
Receiving user input identifying a switching operation on a slave virtual object, and, responsive thereto, switching the first slave virtual object to the second slave virtual object.

11. The method according to claim 10, further comprising:
the second slave virtual object inheriting a health value of the first slave virtual object based on a health value percentage, wherein the health value percentage is a ratio of a current health value of the first slave virtual object to a total health value of the first slave virtual object.

12. One or more non-transitory computer readable media comprising computer readable instructions which, when executed, configure a data processing system to perform:
outputting for display on a display device, a master virtual character and a first slave virtual object located in a virtual scene;
determining an attribute value of the first slave virtual object being less than a first threshold;
responsive to the determining, establishing the first slave virtual object to be in an unhealthy state; and
receiving user input initiating an interaction operation of the master virtual character on a target virtual character, the target virtual character being a virtual character redeemed or defeated by the master virtual character;
transitioning the first slave virtual object from the unhealthy state to a healthy state in response to the user input.

13. The computer readable media according to claim 12, wherein the attribute information comprises skill information; and the first slave virtual object inherits a skill based on the target virtual character.

14. The computer readable media according to claim 13, wherein the skill based on the target virtual character is a second skill in addition to a first skill associated with the first slave virtual character, wherein the first skill is a skill unique to the first slave virtual object, and the second skill is a skill unique to the target virtual character.

15. The computer readable media according to claim 13, wherein the skill based on the target virtual character is a third skill that replaces a first skill associated with the first slave virtual character, wherein the first skill is a skill unique to the first slave virtual object, and the second skill is the skill based on the target virtual character, and wherein the second skill is unique to the target virtual character.

16. The computer readable media according to claim 12, wherein the computer readable instructions, when executed, further configure the data processing system to perform:
switching the first slave virtual object from a first form to a second form in response to the attribute value of the first slave virtual object being less than the first threshold and the first slave virtual object entering the unhealthy state,
wherein the first form is a form in which the first slave virtual object acts independently of the master virtual character, and the second form is a form in which the first slave virtual object is attached to a body part of the master virtual character to become a part of the master virtual character.

17. The computer readable media of claim 16, wherein the computer readable instructions, when executed, further configure the data processing system to perform:
displaying a picture of the first slave virtual object switching between the first form and the second form in response to receiving user input triggering a form switching operation on the first slave virtual object in the healthy state,
wherein the first slave virtual object in the first form is available to attack the target virtual character; and the first slave virtual object in the second form increases an attribute value of the master virtual character.

18. A system, comprising:
a processor; and
memory storing computer readable instructions which, when executed, configure the system to perform:
outputting for display on a display device a master virtual character and a first slave virtual object located in a virtual scene;
determining an attribute value of the first slave virtual object being less than a first threshold;
responsive to the determining, establishing the first slave virtual object to be in an unhealthy state; and
receiving user input initiating an interaction operation of the master virtual character on a target virtual character, the target virtual character being a virtual character redeemed or defeated by the master virtual character;
transitioning the first slave virtual object from the unhealthy state to a healthy state in response to the user input.

19. The computer readable media according to claim 18, wherein the attribute information comprises skill information; and the first slave virtual object inherits a skill based on the target virtual character.

20. The computer readable media according to claim 18, wherein the computer readable instructions, when executed, further configure the data processing system to perform:
switching the first slave virtual object from a first form to a second form in response to the attribute value of the first slave virtual object being less than the first threshold and the first slave virtual object entering the unhealthy state,
wherein the first slave virtual object in the first form is available to attack the target virtual character; and the first slave virtual object in the second form increases an attribute value of the master virtual character.
